(19) United States
(12) Patent Application Publication
(10) Pub. No.: US 2008/0091432 A1
(43) Pub. Date: Apr. 17, 2008

(54) System and method for voice control of electrically powered devices

(76) Inventors: Donald Dalton, Naperville, IL (US); Vincent LaBonte, Hoffman Estates, IL (US)

Correspondence Address: Pauley Petersen & Erickson, Suite 365, 2800 West Higgins Road, Hoffman Estates, IL, 60169, US

(21) Appl. No.: 11/582,131

(22) Filed: Oct. 17, 2006

(51) Int. Cl. G10L 21/00

(52) U.S. Cl. 704/275

(57) ABSTRACT

A method and system for controlling electrically powered devices, such as a light or a television, using a spoken command. The method and system of this invention desirably assists physically disabled persons with daily living, such as within an office or residence, allowing the person to operate lights, appliances, and other electrically powered devices by speaking. The system of this invention includes software that is able to receive complex, multi-step spoken commands and parse the commands into the appropriate command signals and route the command signals to the appropriate device.

### BACKGROUND OF THE INVENTION

1. Field of the Invention

This invention is directed to a system and method for assisting a person, particularly a physically disabled person, in aspects of daily living. More particularly, the invention is directed to voice activated control of electrically powered devices.

2. Discussion of Related Art

In recent years, much emphasis has been placed on using technology to assist the physically disabled. Technology exists that allows a person to control a computer with head movements, eye movements, or by voice. However, there is an ongoing need for improved systems for assisting the disabled in daily activities, such as controlling an appliance or opening a garage door. There is a need for an improved central control system that can control various functions around a disabled person's residence or office.

### SUMMARY OF THE INVENTION

A general object of the invention is to provide an interactive daily living interface that incorporates natural speech recognition software, particularly adapted for those with severe disabilities.

The general object of the invention can be attained, at least in part, through a system for controlling electrically powered devices with a human voice. The system includes a central processor and a communication device for transmitting a spoken command to the central processor. A wireless transmitter is in communication with the central processor and in actuating combination with at least a first of the electrically powered devices. A powerline interface controller is also in communication with the central processor and in actuating combination with at least a second of the electrically powered devices.

The system includes software that is executable on the central processor for receiving the spoken command and transforming the spoken command into a command signal. The system also includes software executable on the central processor for directing the command signal through one of the wireless transmitter and the powerline interface controller for actuating the spoken command at the first or the second of the electrically powered devices.

The invention further provides a method for controlling a plurality of electrically powered devices with a human voice. The method includes: providing a communication device for transmitting a spoken command to a central processor; receiving the spoken command with the central processor; transforming the spoken command into a command signal; routing the command signal to one of a wireless transmitter and a powerline interface controller; and actuating the spoken command in one of the plurality of electrically powered devices with the one of the wireless transmitter and the powerline interface controller.

The invention controls a variety of consumer devices anywhere in a home or office from anywhere, for example, within 800 feet of the home by voice, such as by using a wireless headset worn by the user. Devices able to be controlled by this invention include, without limitation, televisions, stereos, DVD players, VHS recorders, telephones, lights, appliances, fans, HVAC thermostats, beds, nurse calls, drapes, doors, security systems, sprinkler systems, sensors, and low voltage automated switches. The invention can also be used to control devices from anywhere in the world using remote access, such as via the Internet. The invention also allows browsing the Internet by voice. The method and system of this invention can incorporate one or more of available protocols to provide the desired control, for example, infrared and infrared routing, X-10, RS-232, Insteon®, UPB™, hardwire, and others.

Commands are spoken into a microphone connected to a central controller, e.g., a computer. Examples of the spoken interaction between the computer controller and the user, according to one embodiment of this invention, include: User: “Computer”, Computer: “I'm listening”; User: “Open the front door”, Computer: “The front door is open”; User: “Start my car”, Computer: “Your car is started”; or User: “Cable channel five five zero”, Computer: “Cable channel is set to five hundred fifty.”

### BRIEF DESCRIPTION OF THE DRAWINGS

These and other objects and features of this invention will be better understood from the following detailed description taken in conjunction with the drawings, wherein:

FIG. 1 is a flow diagram illustrating one embodiment of this invention;

FIG. 2 is a schematic representation of the operation of one embodiment of this invention.

### DESCRIPTION OF PREFERRED EMBODIMENTS

This invention provides a method and system for controlling electrically powered devices, such as a light or a television, with a human voice. The method and system of this invention desirably assists person, e.g., a disabled person, with daily living within a residence and/or office, allowing the person or a caregiver to operate lights, appliances, and other electrically powered devices by speaking. This invention incorporates software that is able to receive complex, multi-step spoken commands and parse the commands into the appropriate command signals and route the command signals to the appropriate device.

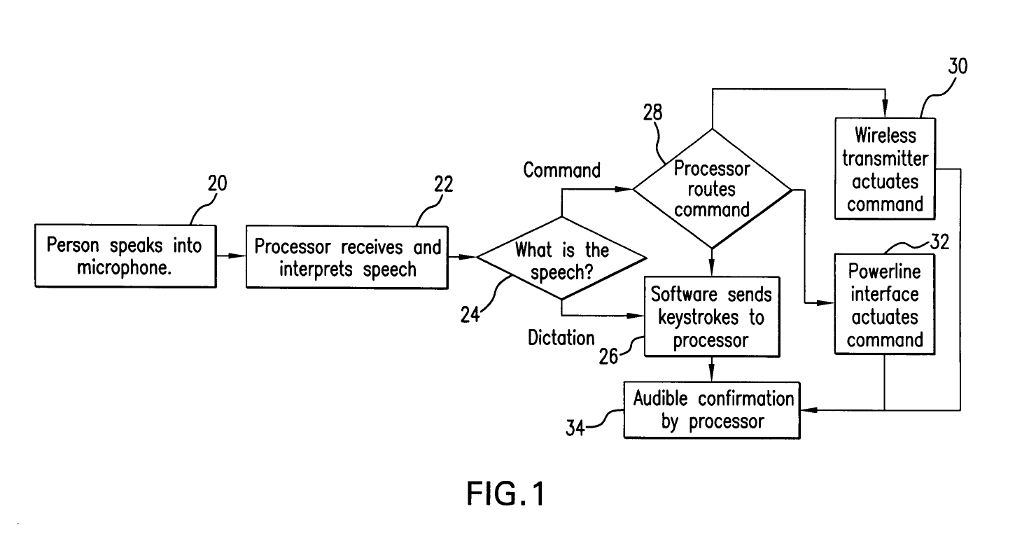

FIG. 1 is a flow diagram illustrating a method according to one embodiment of this invention. The system implementing the method shown in FIG. 1 uses a central processor, e.g., a computer, and a communication device, such as a microphone. A person uses a microphone, which is desirably a wireless headset microphone also having an earphone speaker. The person speaks into the microphone in box 20. The spoken words are transmitted to the processor. In box 22, the processor, and more particularly software being executed on the processor, receives and interprets the spoken words from the microphone.

In box 24, the software, in interpreting the speech, first determines what type of speech has been received. The speech can be a command or may be merely dictation, such as for writing a letter or electronic mail with the processor in any of various word processing programs such as Word®, WordPerfect®, or Outlook®. If the speech is dictation, the software, in box 26, transforms the spoken words into keystrokes that are used as computer input for typing the spoken words as text.

If the received speech is a spoken command, the software transforms the spoken command into a command signal. In one embodiment of the invention, the spoken command is selected from a list of predetermined commands known by the user for use with the system. Once the appropriate command signal is obtained, the processor routs the command in box 28. The command signal is appropriately routed to a device that is able to actuate the command signal, thereby effectuating the spoken command and bringing about the desired result in the appropriate and intended electrically powered device. In one embodiment of this invention, the command signal is routed to either a wireless transmitter or a powerline interface controller. Each of the wireless transmitter and powerline interface is associated with an electrically powered device that is adapted to be able to be controlled by the wireless transmitter or powerline interface, respectively.

The wireless transmitter or the powerline interface actuates the spoken command in the associated electrically powered device upon receiving the command signal in boxes 30 and 32, respectively. In one embodiment of this invention, the wireless transmitter is an infrared transmitter for actuating the spoken command by sending an infrared command signal to the appropriate electrically powered device. Examples of electrically powered devices that can be used with an infrared transmitter include video devices, such as televisions and video players, and audio devices, such as stereo equipment.

The powerline interface can be any device or system that sends a command signal through an existing electrical wire and associated electrical outlet receptacle in an existing structure such as a house. Such powerline interface devices are available in the art for use in remotely activating lights or other appliances or electrical switches. In one embodiment of this invention, the powerline interface includes a powerline interface controller that receives the command signal from the processor and sends the command signal through an existing (in-wall) electrical wire to a powerline interface receiver plugged into or otherwise associated with an electrical outlet receptacle. The powerline interface receiver receives the command signal and actuates a spoken command to bring about the desired affect in the associated electrically powered device, e.g., a lamp or appliance.

In one embodiment of this invention, each electrically powered device, or the powerline interface receiver controlling the device, is assigned a unique device identifier. The spoken command desirably includes an intended device identifier that identifies the device for which the command is given. The command signal is routed to the electrically powered device that has the unique device identifier that matches the intended device identifier, thereby ensuring the intended device is operated.

In one embodiment of this invention, as shown in box 34, an audible confirmation of the spoken command is provided to the user. The audible confirmation is desirably sent to the communication device through which the user provided the original spoken command. The audible confirmation is desirably a computer reproduction of the original spoken command, or a similar variation as discussed above, that confirms each step of the command to the user. The audible confirmation can be provided to the user either before the command is actuated or after the command is actuated. In one embodiment, the audible confirmation is provided after the command is actuated to confirm the command has been followed. In another embodiment, a first audible confirmation can be provided when the commanded action is initiated in the electrically powered device, and a second, and typically different, audible confirmation when the commanded action is completed. For example, where the electrically powered device is an elevator, the first audible confirmation is provided when the commanded action is begun, e.g., “elevator up,” and second audible confirmation is provided when the command is completed, e.g., when the elevator reaches the upper floor.

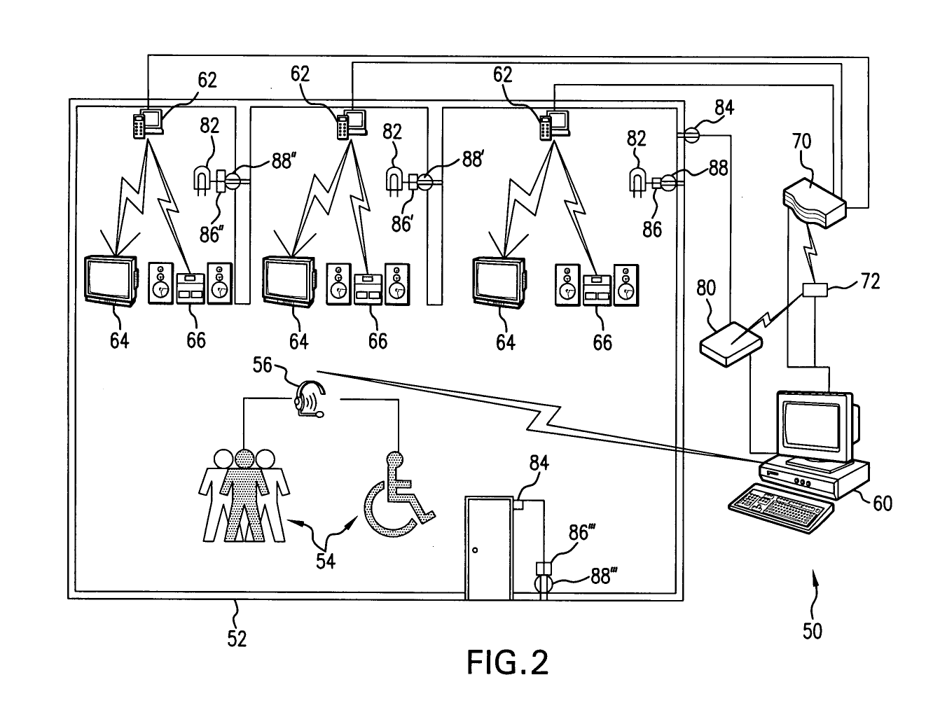

FIG. 2 illustrates a system 50 for controlling electrically powered devices with a human voice according to one embodiment of this invention. The system 50 is installed in and/or operates within a residential structure 52, such as, for example, a disabled person's residence or office. A disabled person or a caregiver 54 uses a communication device, shown as a wireless headset 56 with a microphone to wirelessly transmit a spoken command to a central processor 60.

The central processor 60 includes software executable by the central processor for receiving the spoken command from the headset 56, and transforming the spoken command into a command signal. Such software for receiving and understanding the spoken command is typically referred to as voice recognition software. Examples of voice recognition software that can be adapted for incorporation into the system and method of this invention are available from Nuance Communications, Inc. under the trade name Dragon NaturallySpeaking®. Examples of spoken commands or command signals useful in one embodiment of this invention for a DVD player/recorder, and by no means an exhaustive list, include: “Downstairs DVD on”; “DVD channel <0to9> <0to9> <0to9>”; “DVD channel up”; “DVD menu”; “DVD play”; “DVD pause”; “DVD fast-forward”; etc.

The system 50 includes a plurality of wireless transmitters 62 within the residential structure 52. Each of the plurality of wireless transmitters 62 is in actuating combination with at least one electrically powered device. In FIG. 2, the wireless transmitters 62 are infrared transmitters that are adapted to transmit an infrared signal to at least one, and desirably more than one, electrically powered audio or video device, such as televisions 64 and/or stereos 66. Infrared transmitters are used as remote controls, which also generally utilize infrared signals. Other wireless transmitters can be used, for example, RF transmitters.

The plurality of wireless transmitters 62 are in communication with the processor 60. In the embodiment shown in FIG. 2, a router 70 is in routing combination between the central processor 60 and the wireless transmitters 62. The router 70 can be connected to the central processor by a wired connection or a further wireless transmitter 72. The wireless transmitter 72 is desirably connecter to the processor 60 through a communications port, e.g., a USB or serial port, and can incorporate any type of wireless communication, such as, for example, RF, infrared, IEEE 802.11, or other wireless standard.

A powerline interface controller 80 is also in communication with the central processor either wirelessly or wired to a further communications port. The powerline interface controller 80 is also in actuating combination with electrically powered devices, shown in FIG. 2 as lighting devices 82, e.g., lamps, or door opening device 84. The powerline interface controller 80 sends the command signal through an electrical outlet receptacle 84 and into existing in-wall wiring of the residential structure 52. The electric command signal travels through the wiring to a powerline interface receiver 86 plugged into another electrical outlet receptacle 88 and electrically associated with one lighting devices 82.

Various powerline interface systems are available to those skilled in the art for use with the present invention. Exemplary powerline interface protocols include, without limitation, the RS-232 protocol, the X-10 protocol, or the UPB™ protocol. In one particularly preferred embodiment, the system of this invention incorporates or operates with the Insteon® protocol. The Insteon® protocol, developed by Smartlabs, Inc. (Irvine Calif.), uses powerline, RF, or both. In addition to lighting devices, appliances, thermostats, security systems, sprinklers, sensors, or low voltage automated switches are examples of electrically powered devices that can be networked using RF and/or powerline communications. The Insteon® protocol is disclosed in U.S. Patent Application Publication 2006/0126617, published 15 Jun. 2006, entitled Mesh Network of Intelligent Devices Communicating via Powerline and Radio Frequency, herein incorporated by reference in its entirety.

Upon determining that the received speech is a recognized spoken command, the software transforms the spoken command into a command signal. Additional software that is executable by the central processor directs the command signal through a wireless transmitter 62 and/or the powerline interface controller 80, which in turn actuate the spoken command at the intended electrically powered device(s). In one embodiment, the software for receiving the spoken command and transforming the spoken command into the command signal is desirably integrated into the software for directing the command.

The software desirably includes code for parsing and implementing a multipart spoken command. For example, the collective software is able to receive the spoken command “cable to DVD.” In this example, which for demonstration purposes will be described as executed on a Sony Bravia™ television (Model KDL V40XBR1), the software identifies and initiates command signals for the following commands to change the television input from cable to the DVD player and turn on the DVD player: 1) “TV gate button”; 2) “TV down arrow three steps”; 3) “TV enter button”; 4) “TV down arrow three steps”; 5) “TV enter button”; and 6) “DVD cycle power”. The software then directs the command signal for each command to the appropriate electrically powered device. The command signals 1-5 are directed through a wireless (infrared) transmitter to the television and command signal 6 is directed through the same wireless transmitter to the DVD player.

As another example, the spoken command “TV movie time” can be used to implement the commands discussed above plus dimming the lights. The command signal for dimming the lights is directed through a powerline interface system to actuate the command for the lights in the room by one or more associated powerline interface receivers. The invention allows a user to implement a user created command, such as “TV movie time”, by establishing a spoken command and associating the desired system commands to the spoken command through the system software.

As discussed above, in one embodiment of this invention, the processor 60 includes software that repeats the spoken command in an audible command confirmation back to the person 54 giving the command. In the embodiment of FIG. 2, the wireless headset 56 includes a speaker as well as a microphone, through which the audible command confirmation can be made.

Thus, the invention provides a method and system that desirably assists disabled persons with daily living within a residence, allowing the person or a caregiver to operate lights, appliances, and other electrically powered devices by speaking.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A system for controlling electrically powered devices with a human voice, comprising:
a central processor;
a communication device for transmitting a spoken command to the central processor;
a wireless transmitter in communication with the central processor and in actuating combination with at least a first of the electrically powered devices;
a powerline interface controller in communication with the central processor and in actuating combination with at least a second of the electrically powered devices;
software executable on the central processor for receiving the spoken command and transforming the spoken command into a command signal; and
software executable on the central processor for directing the command signal through one of the wireless transmitter and the powerline interface controller for actuating the spoken command at the first or the second of the electrically powered devices.

2. The system of claim 1, wherein the communication device comprises a wireless microphone.

3. The system of claim 1, wherein the software for receiving the spoken command and transforming the spoken command into the command signal is integrated into the software for directing the command.

4. The system of claim 1, wherein the software for receiving the spoken command and transforming the spoken command into the command signal comprises code for parsing and implementing a multipart spoken command.

5. The system of claim 1, further comprising software for repeating the spoken command in an audible command confirmation.

6. The system of claim 5, wherein the communication device comprises a wireless headset including a microphone and a speaker.

7. The system of claim 1, wherein the wireless transmitter comprises an infrared transmitter or an RF transmitter.

8. The system of claim 7, wherein the infrared transmitter is adapted to transmit an infrared signal to at least one electrically powered audio or video device.

9. The system of claim 1, further comprising a plurality of wireless transmitters and a router in routing combination between the central processor and more than one of the plurality of wireless transmitters.

10. The system of claim 9, wherein the router is in wireless communication with a second wireless transmitter connected to a USB or serial port of the central processor.

11. The system of claim 1, wherein the first of the electrically powered devices comprises an audio or video device.

12. The system of claim 1, wherein the second of the electrically powered devices comprises a lighting device, an appliance, a thermostat, a security system, a sprinkler system, a sensor, or a low voltage automated switch.

13. A method for controlling a plurality of electrically powered device with a human voice, the method comprising:
providing a communication device for transmitting a spoken command to a central processor;
receiving the spoken command with the central processor;
transforming the spoken command into a command signal;
routing the command signal to one of a wireless transmitter and a powerline interface controller;
actuating the spoken command in one of the plurality of electrically powered devices with the one of the wireless transmitter and the powerline interface controller.

14. The method of claim 13, further comprising providing an audible confirmation of the spoken command through the communication device.

15. The method of claim 13, wherein the wireless transmitter is an infrared transmitter and actuating the spoken command with the wireless transmitter comprises sending an infrared command signal to the one of the plurality of electrically powered devices.

16. The method of claim 15, wherein the one of the plurality of electrically powered devices comprises an audio or video device.

17. The method of claim 13, wherein actuating the command in the electrically powered device with the powerline interface controller comprises sending a command signal through an electrical wire and an electrical outlet receptacle of an existing structure to a powerline interface receiver plugged into the electrical outlet receptacle and electrically associated with the one of the plurality of electrically powered devices.

18. The method of claim 17, wherein the one of the plurality of electrically powered devices comprises a lighting device.

19. The method of claim 13, further comprising:
assigning each electrically powered device a unique device identifier;
receiving an intended device identifier in the spoken command; and
routing the command signal to the one of the plurality of electrically powered devices having the unique device identifier that matches the intended device identifier.

20. The method of claim 13, further comprising:
receiving a multipart spoken command; and
parsing the multipart spoken command into a plurality of command signals.
